(19) United States
(12) Patent Application Publication
(10) Pub. No.: US 2006/0171700 A1
(43) Pub. Date: Aug. 3, 2006

(54) Flashlight with image capturing function and recharging device therefor

(76) Inventors: Yu-Hsi Yang, Taipei (TW); Li-Wen Wang, Taipei City (TW); Yi-Lung Weng, Keelung (TW); Ching-Horng Hsiao, Shalu-Township (TW); Chaochi Huang, Taipei (TW)

Correspondence Address: Raymond Sun, 12420 Woodhall Way, Tustin, CA, 92782, US

(21) Appl. No.: 11/184,175

(22) Filed: Jul. 18, 2005

(30) Foreign Application Priority Data
Jan. 28, 2005 (TW) 94102598

(51) Int. Cl. G03B 19/00; G03B 15/03

(52) U.S. Cl. 396/155; 396/429

(57) ABSTRACT

A flashlight has a barrel having a front end and a rear end, with a battery disposed inside the barrel. The flashlight also includes a light source disposed at the front end of the barrel, a light source controlling circuit electrically connected with the battery and the light source for controlling the lighting of the light source, a lens assembly provided at the front end of the barrel for capturing an image, and an image processing circuit disposed inside the barrel and electrically connected with the battery and the lens assembly to process and store the captured image. A recharging device can be provided for recharging the battery in the flashlight.

### BACKGROUND OF THE INVENTION

1. Field of the Invention

The present invention relates to a flashlight, and in particular, to a flashlight that has an image capturing function. The present invention is also directed to a recharging device for the flashlight.

2. Description of the Prior Art

Flashlights have become a personal or family necessity in our daily lives. The lighting provided by a flashlight has indeed brought convenience to users in many respects. However, although human beings have used flashlights for a long time, improvements made to the flashlight, compared to that of other consumer electronics, have been minimal.

Recently, the runtime of flashlights has been extended with the help of advances in electronic technology, such as by using a low-power and high-brightness light emitting diode (LED) as the light source. In addition, this type of flashlight has been widely used by the police and the military. To maintain its useability, the flashlight is usually equipped with a flashlight charger to replenish its power. However, a traditional flashlight performs no other functions other than lighting. For police and military applications, which sometimes require the gathering of photographic evidence, or for individuals who enjoy electronic gadgets, it is desirable to provide a conventional flashlight with additional utility and functions.

### SUMMARY OF THE INVENTION

It is an object of the present invention to provide a flashlight with an image capturing function.

It is another object of the present invention to provide a flashlight having an image capturing function that operates in both daytime and stealth modes.

It is yet another object of the present invention to provide a flashlight having an image capturing function, where the captured image can be transmitted to a computer through a serial data bus.

It is yet another object of the present invention to provide a recharging device for recharging a flashlight.

In order to accomplish the objects of the present invention, the present invention provides a flashlight having a barrel having a front end and a rear end, with a battery disposed inside the barrel. The flashlight also includes a light source disposed at the front end of the barrel, a light source controlling circuit electrically connected with the battery and the light source for controlling the lighting of the light source, a lens assembly provided at the front end of the barrel for capturing an image, and an image processing circuit disposed inside the barrel and electrically connected with the battery and the lens assembly to process and store the captured image.

The present invention also provides a recharging device for recharging the battery in the flashlight. The flashlight includes a barrel, a terminal cover protruding from the barrel, and at least one charging terminal disposed on the terminal cover. The recharging device includes a device body having an accommodation space to receive the barrel, a mechanism for guiding the terminal cover in a preset direction into the device body, a charging interface corresponding to the at least one charging terminal, and a buffering slide disposed in the accommodation space at a location that corresponds to the location of the terminal cover inside the accommodation space, with the buffering slide elastically sildably connected with the device body.

### BRIEF DESCRIPTION OF THE DRAWINGS

FIG. 1 is a perspective view of a flashlight in accordance with one embodiment of the present invention.

FIG. 2 is an exploded perspective view of the flashlight of FIG. 1.

FIG. 3 is an exploded perspective view of the keypad assembly of the flashlight of FIG. 2.

FIG. 4 is an exploded perspective view of the head and the circuit board fixed assembly of the flashlight of FIG. 2.

FIG. 5 is an assembled perspective view of the head and the circuit board fixed assembly of FIG. 4 shown without the screwed sleeve.

FIG. 6 is an exploded perspective view of the liquid crystal display (LCD) panel assembly of the flashlight of FIG. 2.

FIG. 7 is a front perspective view of a recharging device according to one embodiment of the present invention for recharging the flashlight of FIG. 1.

FIG. 8 is a side perspective view of the recharging device of FIG. 7.

FIG. 9 is a front perspective view of the recharging device of FIG. 7 shown without its case.

FIG. 10 is a rear perspective view illustrating the connection between the buffering slide and the device body of the recharging device of FIG. 7.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

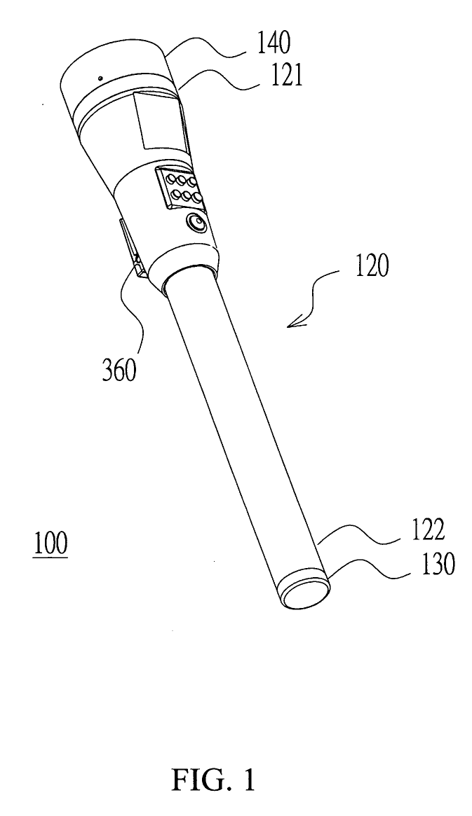

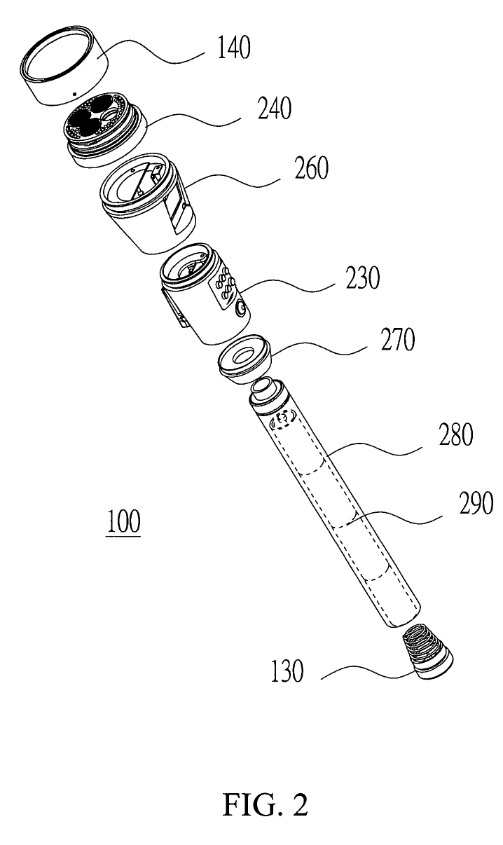

FIG. 1 is a perspective view of a flashlight 100 in accordance with one embodiment of the present invention. This flashlight 100 incorporates an image capturing function. Referring to FIGS. 1 and 2, the flashlight 100 includes a head 140, a barrel 120, and a tail cap 130. The barrel 120 is provided with a front end 121 and a rear end 122, with the head 140 connected to the front end 121 of the barrel 120. A power source, such as one or more batteries 290, providing power to the flashlight 100 can be mounted into the barrel 120 through the rear end 122, and the tail cap 130 can then be used to close the rear end 122 of the barrel 120.

Referring now to FIG. 2, the flashlight 100 includes a circuit board fixed assembly 240, a liquid crystal display (LCD) panel assembly 260, a keypad assembly 230, an adapter ring 270, and a battery compartment 280, which are arranged in sequence in this particular order, extending from the head 140 to the tail cap 130.

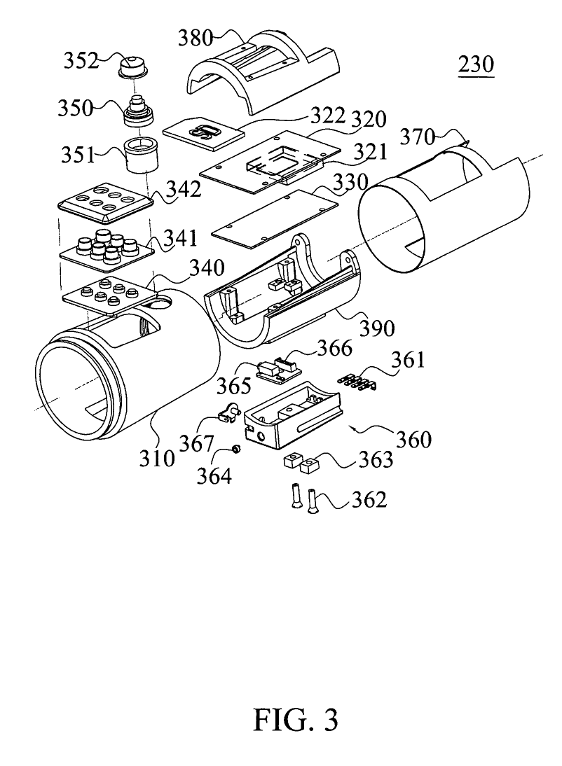

Referring now to FIG. 3, the keypad assembly 230 includes a keypad seat 310, a digital video camera circuit 320, a light source controlling circuit 330, a keypad 340, a button 350, a terminal cover 360, a water-proof shield 370, an upper fixed frame 380, and a lower fixed frame 390. FIG. 3 illustrates the inter-relationship of these components of the keypad assembly 230.

The digital video camera circuit 320 is provided with a memory card interface 321 and a universal serial bus (USB), which is not shown, but which is well-known in the art. A memory card 322 can be arranged in the memory card interface 321 to store the images captured, and the USB functions to output the image data stored in the memory card 322. The digital video camera circuit 320 includes circuitry to facilitate operation in both daytime and stealth modes so that images can be taken, processed, and stored both during the daytime (i.e., in bright environments) and in dark environments (e.g., during nighttime or in dark rooms). Alternatively, the digital video camera circuit 320 can be replaced by an image processing circuit that operates only in either the daytime mode or the stealth mode, and as a further alternative, it can even be replaced by a digital still camera circuit.

The light source controlling circuit 330 is adapted to be electrically connected with the batteries 290 in the barrel 120 to control and provide power for the flashlight 100. The light source controlling circuit 330 and the digital video camera circuit 320 are retained in an interior space defined by the lower fixed frame 390 and the upper fixed frame 380. In particular, the light source controlling circuit 330 and the digital video camera circuit 320 are secured on the lower layer and the upper layer, respectively, of the lower fixed frame 390. The lower fixed frame 390 is in turn attached to the upper fixed frame 380. The combined lower fixed frame 390 and the upper fixed frame 380 is covered by a waterproof shield 370 (which can be made of rubber or plastic), and then the shield 370 (together with the fixed frames 380, 390) are disposed inside the bore of the generally-tubular keypad seat 310.

The keypad 340 functions to control the digital video camera circuit 320, and is (i) secured on the upper fixed frame 380 (via corresponding openings in the keypad seat 310 and the shield 370), (ii) electrically connected with the digital video camera circuit 320, and (iii) topped with a keypad cap 341 and a keypad cover 342. A button 350 functions to control the on/off operation of the flashlight 100. The button 350 is retained inside a button cap 351 which extends through an opening in the keypad seat 310. The button 350 is secured to the keypad seat 310. In addition, a button cap 352 is fitted on top of the button 350.

The terminal cover 360 functions to secure USB terminals 361 of the assembled USB interface, charging terminals 362 of the assembled charging interface, electrode seats 363, a microphone 364, a video-audio output terminal 365, a terminal block 366, and a waterproof plug 367, all of which are secured to the lower fixed frame 390 by the charging terminals 362. The USB terminals 361, the microphone 364, and the video-audio output terminal 365 can be electrically connected to the digital video camera circuit 320 through the terminal block 366.

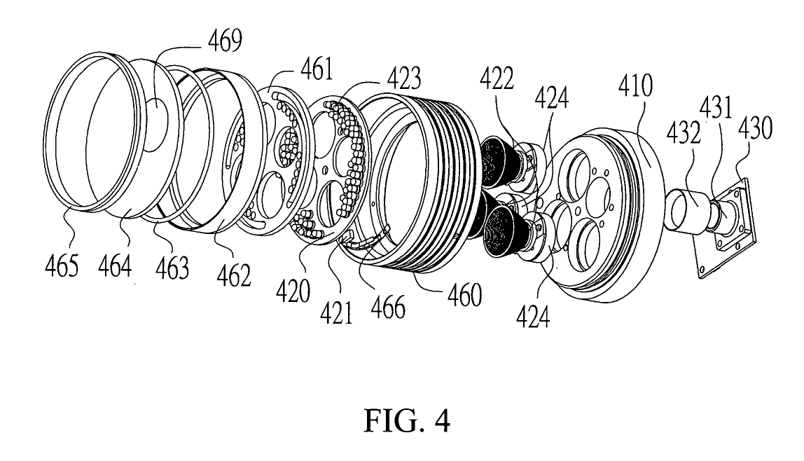

FIG. 4 is an exploded perspective view of the head 140 and the circuit board fixed assembly 240 of FIG. 2. The circuit board fixed assembly 240 includes a circuit board fixed seat 410, an LED circuit board 420, a plurality of bulb cup modules 424, and a lens circuit board 430. A lens 431 and a shade 432 are provided on the lens circuit board 430. The lens circuit board 430 has an image sensing circuit, such as a charge coupled device (CCD), which is electrically connected to the digital video camera circuit 320. The image sensing circuit and the lens 431 combine to provide the function of capturing images. The bulb cup modules 424 are electrically connected to the light source controlling circuit 330 and provide the main light source of the flashlight 100. Each bulb cup module 424 has a bulb cup 422 having white LEDs (not shown) arranged therein. The circuit board fixed seat 410 functions to secure the LED circuit board 420, the bulb cup modules 424, and the lens circuit board 430.

The LED circuit board 420 electrically connects the light source controlling circuit 330, and includes a mode switch 421 and a plurality of infrared (IR) LEDs 423 that provide lighting for capturing images in the stealth mode. The mode switch 421 functions to detect the image capturing mode so that when a user switches between the daytime or stealth modes, the way that the digital video camera circuit 320 processes images can also change accordingly. In this regard, when a user selects the stealth mode of operation, the light source controlling circuit 330 cuts off the power to the white LEDs in the bulb cups 422, to prevent the white LEDs in the bulb cups 422 from being accidentally turned on when the flashlight 100 is being used to gather evidence in the stealth mode. The switching between the daytime and stealth modes will be explained below.

The head 140 includes a screwed sleeve 460, a decoration disk 461, a lens seat 462, an O-ring 463, a lens 464, a clamping ring 465, and a switch spring plate 466. The clamping ring 465, the lens 464, and the O-ring 463 are arranged in sequence (in this particular order) on the lens seat 462, and are secured by both the outer threads (not shown) of the clamping ring 465 and inner threads (not shown) of the lens seat 462. The combined clamping ring 465, the lens 464, and the O-ring 463 are then pressed, along with the decoration disk 461, into the screwed sleeve 460 to complete the assembly of the head 140. In addition, the screwed sleeve 460 is locked into the circuit board fixed frame 410 via a lock mechanism (not shown), so that the head 140 can be rotated with respect to the circuit board fixed assembly 240 to switch between the daytime and stealth modes.

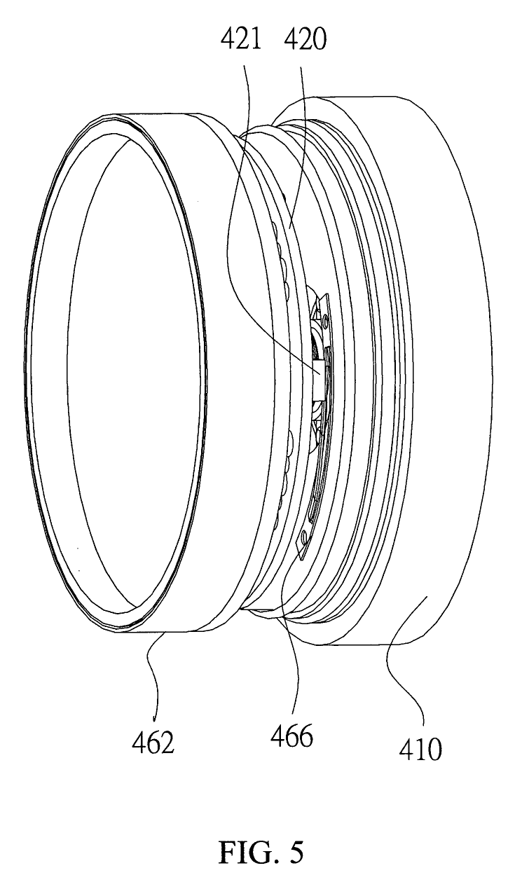

FIGS. 4 and 5 illustrate the switching between the daytime and stealth modes. In FIG. 4, an infrared filtering film 469 is arranged on the lens 464 at a location that can be aligned with the location of the lens 431, and functions to filter infrared light when a user switches to the daytime mode, thereby preventing color from shifting on images taken. In FIG. 5, the switch spring plate 466 corresponds to the mode switch 421, with the switch spring plate 466 secured to the screwed sleeve 460, so that the switch spring plate 466 would rotate when the screwed sleeve 460 rotates. On the other hand, the mode switch 421 is always in a fixed location (i.e., cannot move) because it is disposed on the LED circuit board 420 which is in turn secured to the circuit board fixed seat 410. Thus, rotating the screwed sleeve 460 will cause the switch spring plate 466 to rotate, which in turn presses the stationary mode switch 421 to turn on or turn off the contact of the mode switch 421.

Referring to FIG. 6, the LCD panel assembly 260 includes a generally tubular LCD panel seat 610, a rubber seat 621, an LCD panel 620, a pressure disk 622, a protection plate 623, an LED drive circuit 630, an LCD circuit seat 640, and an LCD circuit 650. The rubber seat 621, the LCD panel 620, the pressure disk 622, and the protection plate 623 are arranged in sequence (in this particular order) and seated in an opening in the LCD panel seat 610. The LED drive circuit 630 is secured to an end of the LCD panel seat 610, and the LCD circuit 650 is first secured on the LCD circuit seat 640 and is then secured on the LCD panel seat 610.

In use, the user uses the flashlight 100 by turning on or off the white LEDs in the bulb cups 422. When a user wishes to use the flashlight 100 to capture images in the stealth mode, the user turns the head 140 to move the infrared filtering film 469 of the lens 464 away from an aligned position with the lens 431. As a result, the infrared light from the infrared LEDs 423 will not be filtered in the stealth mode. Then, the switch spring plate 466 is moved to the position above the mode switch 421 to switch on the contact of the mode switch 421. This will allow the digital video camera circuit 320 to change the way it processes captured images (i.e., bright or dark), and the light source controlling circuit 330 will switch on the power of the infrared LEDs 423 to act as the primary light source during the stealth mode. In addition, the light source controlling circuit 330 cuts off the power to the white LEDs in the bulb cups 422, to prevent the white LEDs in the bulb cups 422 from being accidentally turned on. With the infrared LEDs 423 providing infrared light, the user can then capture images by actuating the keys on the keypad 340. The images are captured via the lens 431 and then provided to the digital video camera circuit 320 for processing. The user can view the captured images on the LCD panel 620.

When a user wishes to use the flashlight 100 to capture images in the daytime mode (i.e., in a bright environment), the user turns the head 140 to move the infrared filtering film 469 of the lens 464 to a location that is aligned with the position of the lens 431. This will cause infrared light to be filtered. The user can then capture images by actuating the keys on the keypad 340. The images are captured via the lens 431 and then provided to the digital video camera circuit 320 for processing. The user can view the captured images on the LCD panel 620.

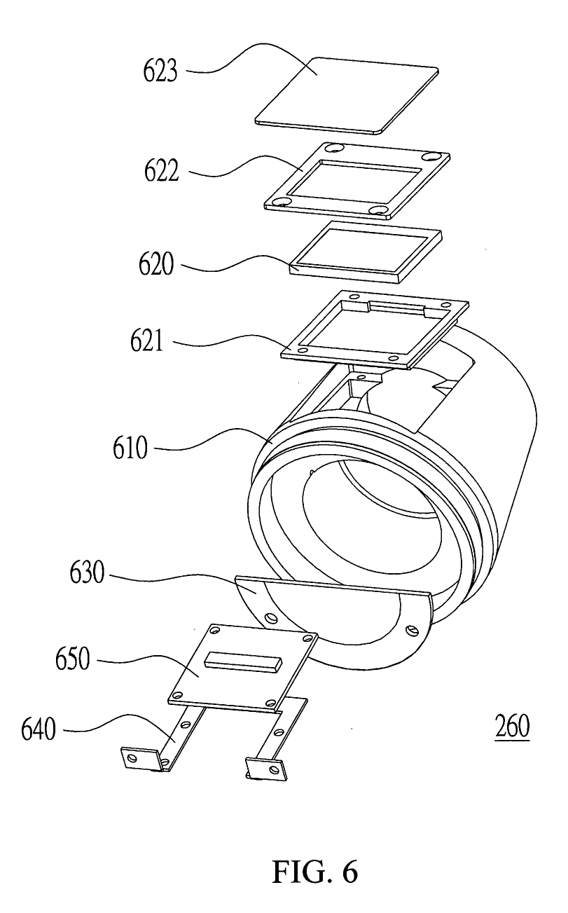

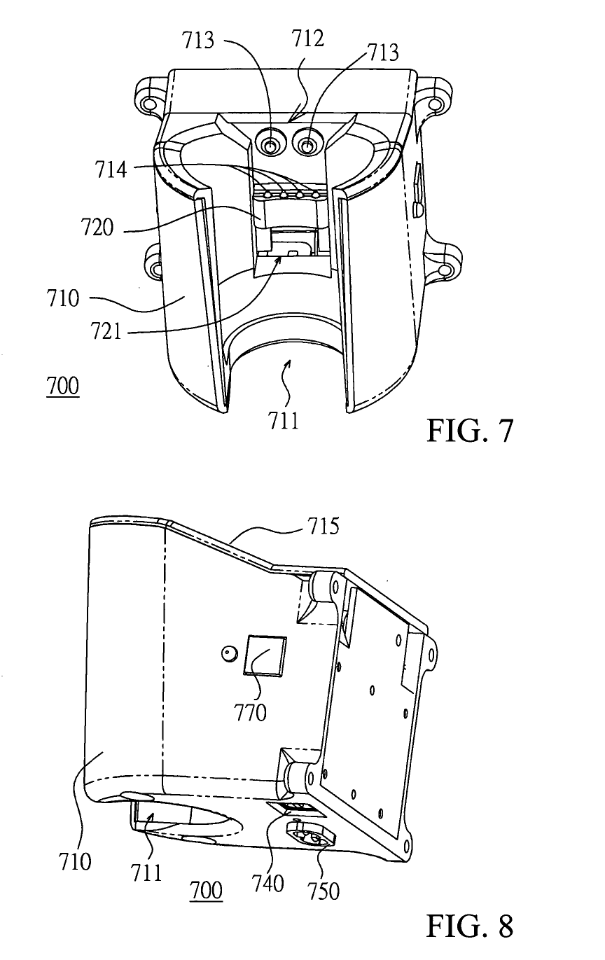

FIGS. 7-10 illustrate a recharging device 700 that can be used for recharging the flashlight 100 shown in FIGS. 1-6. The terminal cover 360 of the flashlight 100 extends from one side of the barrel 120, and is provided with the charging terminals 362 and the USB terminals 361 shown in FIG. 3 and described above. Consequently, a device body 710 of the recharging device 700 is provided with an accommodation space 711 for receiving the barrel 120 of the flashlight 100, and a concave region 712 is provided in the accommodation space 711 to receive the terminal cover 360. Also, a charging interface 713 (adapted to engage the charging terminals 362) and data transmission terminals 714 (adapted to engage the USB terminals 361) are provided in the concave region 712 of the device body 710.

To allow the flashlight 100 to be conveniently mounted onto the recharging device 700, the top of the device body 710 of the recharging device 700 includes a tapered region 715 that has a gradual increase in height in a preset direction. As a result, when the flashlight 100 is mounted onto the recharging device 700, the terminal cover 360 protruding from the flashlight 100 can be guided by the tapered region 715 in the preset direction as it slides into the concave region 712 of the device body 710. Consequently, the charging terminals 362 and the USB terminals 361 can engage the charging interface 713 and the data transmission terminals 714, respectively, of the recharging device 700.

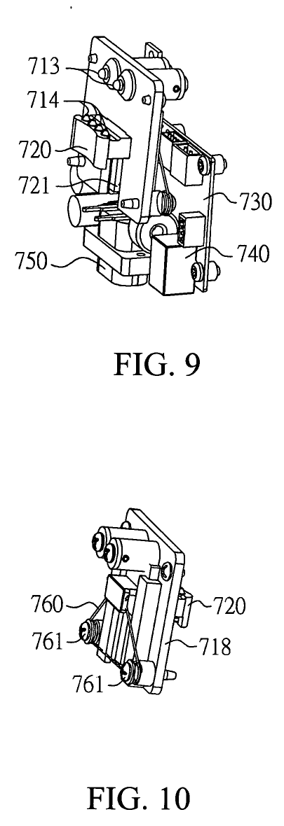

Moreover, to minimize damage to the terminals on the flashlight 100 as the flashlight 100 slides into the recharging device 700, the data transmission terminals 714 are provided on the top of a buffering slide 720. See FIGS. 7 and 9. The buffering slide 720 can be elastically coupled with the device body 710 of the recharging device 700 for movement along a guide 721.

FIG. 9 is a perspective view of the recharging device 700 without its case, and illustrates the buffering slide 720, the charging interface 713, and the data transmission terminals 714, as well as a charging circuit 730, a USB port 740, and a power socket 750 inside the device body 710 of the recharging device 700. The charging circuit 730 is electrically connected to the charging interface 713 and the power socket 750 to convert electricity from the power socket 750 to charge the batteries 290 disposed in the flashlight 100. The USB port 740 is electrically connected with the data transmission terminals 714 to connect with the USB in a personal computer, into which the image data stored in the flashlight 100 can be uploaded.

Referring to FIG. 8, for a user to upload the image data stored in the flashlight 100 into a personal computer, the recharging device 700 includes a switch 770 arranged between the data transmission terminals 714 and the USB port 740. When the user mounts the flashlight 100 onto the recharging device 700 that is connected with a computer, the user can press the switch 770 to connect the digital video camera circuit 320 of the flashlight 100 with the personal computer through the USB, thereby prompting the personal computer to download the image data stored in the flashlight 100.

FIG. 10 illustrates the connection between the buffering slide 720 and the device body 710. A hairclip spring 760 is disposed on the buffering slide 720, and one side of the hairclip spring 760 is secured to a terminal plate 718 of the device body 710 by screws 761 to provide an elastic connection between the buffering slide 720 and the device body 710. This elastic connection provides a buffering function when the flashlight 100 slides onto the recharging device 700.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A flashlight, comprising:
a barrel having a front end and a rear end, with a battery disposed inside the barrel;
a light source disposed at the front end of the barrel;
a light source controlling circuit disposed inside the barrel and electrically connected with the battery and the light source for controlling the lighting of the light source;
a lens assembly provided at the front end of the barrel for capturing an image; and
an image processing circuit disposed inside the barrel and electrically connected with the battery and the lens assembly to process and store the captured image.

2. The flashlight of claim 1, further including a serial data transport interface disposed on the barrel and electrically connected with the image processing circuit to output the image.

3. The flashlight of claim 1, wherein the light source includes at least one white light emitting diode.

4. The flashlight of claim 3, wherein the light source further includes a plurality of infrared light emitting diodes

5. The flashlight of claim 1, wherein the image processing circuit comprises:
a memory card;
a digital video camera circuit having a memory card interface into which the memory card can be inserted to store images;
a liquid crystal display panel electrically connected to the digital video camera circuit to display the images; and
a keypad electrically connected to the digital video camera circuit.

6. The flashlight of claim 5, wherein the barrel includes:
a battery compartment for accommodating the battery;,
an adapter ring connected with the battery compartment;
a keypad seat connected with the adapter ring to receive the digital video camera circuit, the keypad, and the light source controlling circuit;
a liquid crystal display panel seat connected with the keypad seat to receive the liquid crystal display panel; and
a circuit board fixed seat connected with the liquid crystal display panel seat to receive the light source and the lens assembly.

7. The flashlight of claim 6, further including a first charging terminal and a second charging terminal disposed on the keypad seat.

8. The flashlight of claim 1, further comprising a head rotatably connected to the front end of the barrel, the head including a lens with an infrared filtering film that is aligned with the lens assembly, and wherein the head is rotated to move the filtering film away from its alignment with the lens assembly.

9. The flashlight of claim 8, further comprising a mode switch electrically connected to the image processing circuit to switch the image processing circuit between a daytime mode and a stealth mode when the head rotates relative to the barrel.

10. The flashlight of claim 2, wherein the serial data transport interface is a universal serial bus.

11. An assembly, comprising:
a flashlight including a barrel, a terminal cover protruding from the barrel, and at least one charging terminal disposed on the terminal cover;
a recharging device removably coupled to the flashlight for recharging the battery in the flashlight, comprising:
a device body having an accommodation space that receives the barrel, and a mechanism for guiding the terminal cover in a preset direction into the device body;
a charging interface corresponding to the at least one charging terminal; and
a buffering slide disposed in the accommodation space at a location that corresponds to the location of the terminal cover inside the accommodation space, the buffering slide elastically slidably connected with the device body.

12. The assembly of claim 11, wherein the recharging device further includes a hairclip spring that provides an elastic connection between the buffering slide and the device body.

13. The assembly of claim 11, wherein the mechanism is an tapering region provided on a top surface of the device body, the tapering region having a gradual increase in height from the preset direction.

14. The assembly of claim 11, wherein the terminal cover is further provided with a serial data transport interface, and wherein a plurality of terminals are disposed on the device body corresponding to the serial data transport interface.

15. The assembly of claim 14, wherein the serial data transport interface is a universal serial bus.

16. The assembly of claim 15, wherein the terminals of the universal serial bus are disposed on the top of the buffering slide.

17. The assembly of claim 15, further comprising a universal serial bus port disposed on the bottom of the device body and electrically connected to the terminals of the universal serial bus.

18. The assembly of claim 17, further comprising a switch disposed between the terminals of the universal serial bus and the universal serial bus port.

19. The assembly of claim 11, further comprising a charging circuit disposed in the device body and electrically connected with the charging interface.

20. The assembly of claim 19, further comprising a power socket disposed on the bottom of the device body and electrically connected with the charging circuit.

21. An assembly, comprising:
a flashlight including a barrel, a terminal cover protruding from the barrel, and at least one charging terminal disposed on the terminal cover; and
a recharging device removably coupled to the flashlight for recharging the battery in the flashlight, comprising:
a device body having an accommodation space that receives the barrel;
a charging interface corresponding to the at least one charging terminal; and
wherein the terminal cover is provided with a serial data transport interface, with a plurality of terminals disposed on the device body corresponding to the serial data transport interface.
